(19) United States
(12) Patent Application Publication
(10) Pub. No.: US 2024/0233697 A1
(43) Pub. Date: Jul. 11, 2024

(54) SUBWOOFER AND FOOT PEDAL MECHANISM FOR DIGITAL PIANO

(71) Applicant: Steinway Musical Instruments, Inc., New York, NY (US)

(72) Inventors: Benjamin Kelley Smith, Astoria, NY (US); Gary Albert Girouard, Falmouth, MA (US)

(21) Appl. No.: 18/093,470

(22) Filed: Jan. 5, 2023

(51) Int. Cl. G10H 1/34; H04R 1/02; H04R 1/28

(52) U.S. Cl. CPC G10H 1/348; H04R 1/025; H04R 1/2826; G10H 2220/311

(57) ABSTRACT

A digital piano includes a plurality of keys, a foot pedal mechanism positioned below the plurality of keys, a subwoofer positioned below the plurality of keys, and a controller operably connected to the plurality of keys, the foot pedal mechanism, and the subwoofer, the controller configured to cause the digital piano to produce an audible output based on at least a user input on the plurality of keys, at least a portion of the audible output being emitted by the subwoofer.

### TECHNICAL FIELD

This specification relates to a subwoofer and a foot pedal mechanism for a digital piano.

### BACKGROUND

An acoustic piano is an instrument that can include piano keys, hammers, strings, and a soundboard connected to the strings. In response to input to the piano keys, a hammer physically hits the corresponding strings to create an audible output. The sound waves of the audible output propagate through the soundboard.

A digital piano can include piano keys, a foot pedal mechanism, and a controller connected to the foot pedal mechanism and the piano keys. The digital piano can include a speaker or be connected to an external speaker. A user can interact with the piano keys and/or the foot pedal mechanism to generate one or more signals received by the controller. In response to user input to the piano keys and/or the controller, the controller operates the speaker to emit an audible output.

### SUMMARY

This disclosure describes a digital piano with a subwoofer for emitting audible output of the digital piano that provides tactile feedback to a user of the digital piano that emulates the feedback provided by an acoustic piano. The subwoofer can be connected to a foot pedal mechanism that allows a user to modulate the audible output by pressing pedals on the pedal mechanism. The subwoofer and the foot pedal mechanism can be positioned so that the sound waves emitted from the subwoofer can travel through the foot pedal mechanism and thereby can be felt by the user during use of the digital piano.

In one aspect, a digital piano is featured. The digital piano includes a plurality of keys, a foot pedal mechanism positioned below the plurality of keys, a subwoofer positioned below the plurality of keys, and a controller operably connected to the plurality of keys, the foot pedal mechanism, and the subwoofer, the controller configured to cause the digital piano to produce an audible output based on at least a user input on the plurality of keys, at least a portion of the audible output being emitted by the subwoofer.

In another aspect, a pedal and subwoofer assembly for a digital piano is featured. The pedal and subwoofer assembly includes a housing, a foot pedal mechanism mounted to the housing, the foot pedal mechanism configured to generate one or more signals for the digital piano to modulate an audible output produced by the digital piano, and a subwoofer mounted to the housing, the subwoofer configured to generate at least a portion of the audible output produced by the digital piano. The pedal and subwoofer assembly is mountable to the digital piano below keys of the digital piano.

In some implementations, the subwoofer is in contact with the foot pedal mechanism.

In some implementations, the foot pedal mechanism includes a housing, the subwoofer includes a housing, and the housing of the foot pedal mechanism is attached to the housing of the subwoofer, an exterior surface of the housing of the foot pedal mechanism contacting an exterior surface of the housing of the subwoofer. In some implementations, the housing of the subwoofer is positioned on top of the housing of the foot pedal mechanism. In some implementations, the housing of the subwoofer abuts a rear portion of the housing of the foot pedal mechanism. In some implementations, at least one of the exterior surface of the housing of the foot pedal mechanism or the exterior surface of the housing of the subwoofer includes a cushioning member. In some implementations, the housing of the foot pedal mechanism includes one or more port holes facing the subwoofer.

In some implementations, the digital piano further includes a housing for the subwoofer and the foot pedal mechanism.

In some implementations, the foot pedal mechanism and the subwoofer form a module detachable from the digital piano.

In some implementations, the foot pedal mechanism is detachably connected to the subwoofer.

In some implementations, the subwoofer and the foot pedal mechanism are positionable on a floor surface when the digital piano is supported on the floor surface.

In some implementations, the digital piano further includes a panel extending along a rearward portion of the digital piano, the panel covering at least a part of a forward portion of the digital piano. The subwoofer is positioned in the part of the forward portion of the digital piano.

In some implementations, the digital piano further includes a panel extending along a rearward portion of the digital piano, the panel covering at least a part of a forward portion of the digital piano. The subwoofer and the foot pedal mechanism are integrated with the panel.

In some implementations, the digital piano further includes a speaker system that includes a first portion positioned above the plurality of keys and a second portion positioned below the plurality of keys. The second portion of the speaker system includes the subwoofer.

In some implementations, the subwoofer is an enclosed speaker.

In some implementations, a height of the subwoofer is no more than 500 millimeters, a width of the subwoofer is no more than 250 millimeters, and a length of the subwoofer is no more than 300 millimeters.

In some implementations, a speaker of the subwoofer is directed laterally outwardly toward the foot pedal mechanism. In some implementations, the speaker of the subwoofer is positioned above the foot pedal mechanism.

In some implementations, the pedal and subwoofer assembly is positionable on a floor surface when the pedal and subwoofer assembly is mounted to the digital piano and when the digital piano is supported on the floor surface.

In some implementations, the subwoofer and the foot pedal mechanism are positionable on a floor surface and the digital piano is supported on the floor surface by the subwoofer and the foot pedal mechanism.

In some implementations, the controller is configured to cause the digital piano to produce a sub-audible output based on at least the user input on the plurality of keys, at least a portion of the sub-audible output being emitted by the subwoofer.

Advantages of the systems and methods described in this disclosure may include those described below and elsewhere in this disclosure.

Implementations described in this disclosure (e.g., pedal and subwoofer assemblies and digital pianos) can provide tactile feedback to a user of a digital piano that emulates the feedback provided by an acoustic piano (e.g., a non-digital piano, an acoustic grand piano, etc.). In an acoustic piano, sound waves from vibrating strings can propagate through a soundboard and into a foot pedal mechanism underneath the soundboard. The sound waves can transfer into the user's feet and legs as vibrations through the user's contact with the foot pedal mechanism, providing the user with a distinctive tactile experience. Instead of relying on physical actuation of strings to generate an audible output, a digital piano typically uses control signals (generated in response to operation of digital keys of the digital piano) for controlling an audible output from a speaker, which may not provide the same tactile experience as in an acoustic piano.

To provide tactile feedback to the user, a digital piano according to this disclosure can use a subwoofer to emit at least part of the audible output. The subwoofer can be in contact with a foot pedal mechanism located below a keyboard. The sound waves of the audible output emitted from the subwoofer can transfer into the user's feet and legs as vibrations. For example, the sound waves can propagate through the foot pedal mechanism and transfer into the user's feet and legs as vibrations through the user's contact with the foot pedal mechanism. Thus the digital piano can provide a tactile experience that is similar to an acoustic piano and that does not require the use of elaborate physical mechanisms (e.g., strings, hammers, and other mechanisms typically found in acoustic pianos). The digital piano can provide a tactile experience that is similar to an acoustic piano, which may be larger, more expensive, or otherwise inaccessible for practice as compared to a digital piano.

Furthermore, a digital piano in accordance with implementations described in this disclosure can be easier and less costly to maintain than an acoustic piano. For example, acoustic pianos have physical strings that go out of tune over time. A digital piano does not have strings and uses a controller to generate control signals for controlling an audible output from a speaker, so there is less maintenance required. The subwoofer and foot pedal mechanism can be used with a digital piano so that a user can have the benefit of having a piano that is easily maintained and less costly (e.g., compared to an acoustic piano) and that has the feel of an acoustic piano.

In some implementations, a digital piano can provide a user with a more flexible playing experience. The subwoofer and foot pedal mechanism can form a module that is not fixed to the digital piano and can be moved by the user to a desired position relative to their body and the keyboard such that users can more easily or conveniently use the foot pedal mechanism and experience the tactile feedback offered by the subwoofer. For example, the user may focus their playing on the upper or lower octaves of the keyboard, and on an acoustic piano the user may find it difficult to reach pedals that are fixed under the middle of the keyboard. The position of the subwoofer and foot pedal mechanism can be adjusted to allow the user to more easily reach the pedals and experience the tactile feedback provided by the subwoofer. The position of the subwoofer and foot pedal mechanism module can also be adjusted to accommodate users of different sizes and physical abilities, e.g., to be positioned such that the pedals can be reached by the user and such that the tactile feedback provided by the subwoofer can be felt by the user. If there are multiple users at the same piano, each user may also find it difficult to reach pedals that are positioned under the middle of the keyboard. The position of the subwoofer and foot pedal mechanism module can be adjusted to be closer to one of the users, allowing the user to more easily reach the foot pedal mechanism and experience the tactile feedback of the subwoofer. The digital piano can also have multiple subwoofer and foot pedal mechanism modules to accommodate multiple users so that each user can use a foot pedal mechanism and experience the tactile feedback offered by the subwoofer. Thus the subwoofer and foot pedal mechanism module can provide flexibility to a user or users of the digital piano.

Moreover, implementations described in this disclosure can provide a customizable tactile experience to a user of a digital piano. The digital piano can use a controller to generate control signals for controlling an audible output from a speaker in response to operation of digital keys or a foot pedal mechanism of the digital piano. The digital piano can use a subwoofer to emit at least part of the audible output, which provides tactile feedback to the user as described above. The part of the audible output that the subwoofer emits can be customized by the user. For example, the user can use the controller to select a range of frequencies for the subwoofer to emit. The user can also use the controller to select settings for the audible output of the subwoofer such as volume, filters, or effects. Thus the digital piano can provide a customizable tactile experience based on user preferences for the audible output of the subwoofer.

In addition, the subwoofer and foot pedal mechanism can be detachably connected to each other and positioned differently relative to each other, further allowing a user to customize the tactile experience provided by the digital piano. The subwoofer and foot pedal mechanism can form a module that is detachable from the digital piano and thus easily replaceable if a user wants to replace the subwoofer or foot pedal mechanism.

Implementations described in this disclosure can also provide an audible output that is more resonant, particularly for audible output at lower frequencies, and can emulate the soundwave transmission patterns of an acoustic grand piano. For example, in implementations in which the subwoofer is in contact with the foot pedal mechanism positioned on the floor surface, the sound waves of the audible output emitted from the subwoofer can propagate through the foot pedal mechanism and disperse into the floor, creating a more resonant sound (e.g., that emulates the sound of an acoustic grand piano more closely than a conventional digital piano). In implementations in which the subwoofer is positioned on the floor surface, the sound waves of the audible output emitted from the subwoofer can disperse into the floor.

A digital piano in accordance with implementations described in this disclosure can be more aesthetically appealing. For example, the subwoofer and foot pedal mechanism can form a module that can be separated from the digital piano, giving the digital piano a more modern appearance. For a digital piano that is designed to look like an upright acoustic piano, the subwoofer can be positioned in a front panel. The subwoofer and foot pedal mechanism can also be integrated with the front panel, giving the digital piano a more traditional appearance.

The details of one or more implementations of the subject matter described in this specification are set forth in the accompanying drawings and the description below. Other potential features, aspects, and advantages will become apparent from the description, the drawings, and the claims.

### BRIEF DESCRIPTION OF THE DRAWINGS

FIG. 1 is a top perspective view of an example of a digital piano including a subwoofer and foot pedal mechanism.

FIGS. 2A-2D are top perspective, side, front, and top views of an example of a subwoofer and foot pedal mechanism.

FIGS. 3A-3B are top perspective and top perspective exploded views of another example of a subwoofer and foot pedal mechanism.

FIG. 4 is a top perspective view of another example of a subwoofer and foot pedal mechanism.

FIG. 5 is a top perspective view of an example of a digital piano where the subwoofer is integrated into a panel of the digital piano.

FIG. 6 is a front view of another example of a digital piano where the subwoofer is integrated into a panel of the digital piano.

Like reference numbers and designations in the various drawings indicate like elements.

### DETAILED DESCRIPTION

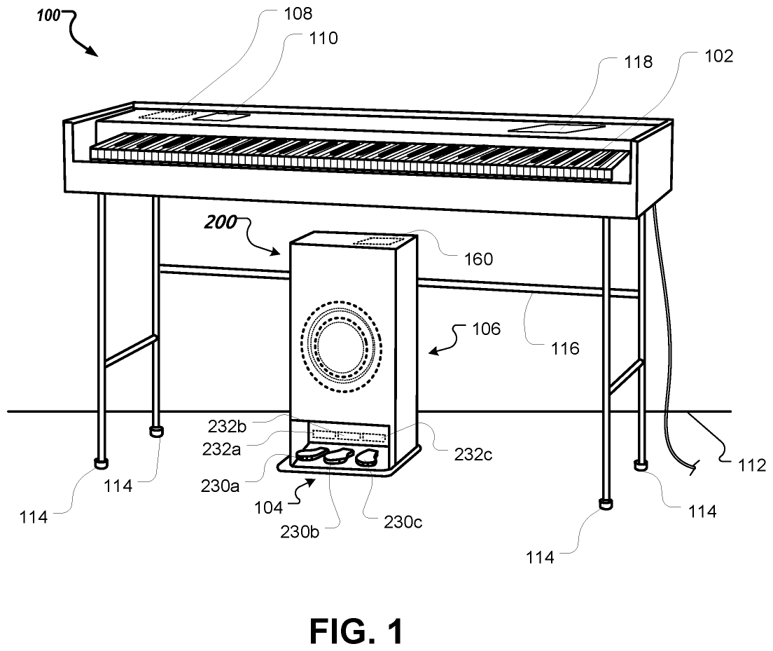

Referring to FIG. 1, an example of a digital piano 100 includes multiple keys 102, a pedal and subwoofer assembly 200, and a controller 108. The pedal and subwoofer assembly 200 includes a foot pedal mechanism 104 positioned below the keys 102 and a subwoofer 106 positioned below the keys 102. The controller 108 is operably connected to the keys 102, the foot pedal mechanism 104, and the subwoofer 106. The controller 108 can cause the digital piano 100 to produce an audible output based on at least a user input on the keys 102. At least a portion of the audible output can be emitted by the subwoofer 106. As discussed in this disclosure, implementations of digital pianos including subwoofer and foot pedal mechanisms can provide an immersive playing experience that allows a user to experience similar tangible feedback and sound quality as they would on an acoustic piano.

As shown in FIG. 1, the pedal and subwoofer assembly 200 can be positioned on a floor surface 112. For example, a bottom surface of the foot pedal mechanism 104 can be positioned on the floor surface 112, and support the pedals 230 and the subwoofer 106 above the floor surface 112. The digital piano 100 can be supported on the floor surface 112, for example, through legs 114 that are fixed to the keyboard as shown in FIG. 1. The digital piano 100 can also be supported on the floor surface 112 through a stand that can support the keyboard. The sound waves of the audible output emitted from the subwoofer can disperse into the floor, creating a more resonant sound that emulates the sound quality of an acoustic grand piano.

As shown in FIG. 1, the pedal and subwoofer assembly 200 can be a standalone module that is in communication (e.g., wireless or wired) with the controller 108 of the digital piano 100 and that is physically positionable relative to the digital piano 100. The pedal and subwoofer assembly 200 can be, for example, positioned in front of a bar 116 between the legs 114 of the digital piano 100. The foot pedal mechanism 104 and subwoofer 106 can be freely positioned relative to the digital piano 100, and the foot pedal mechanism 104 and subwoofer 106 can send and receive signals to the controller 108 wirelessly, further allowing a user to customize their playing experience.

In some implementations, the pedal and subwoofer assembly 200 can form a module that is attachable to the digital piano 100, e.g., to the bar 116 of the digital piano 100. In some implementations, the module can be detached from the bar 116 and re-attached to a different location along the bar 116. For example, the module can be moved by the user to a desired position relative to their body and the keyboard. The position of the module can also be adjusted to accommodate users of different sizes and physical abilities. Furthermore, the position of the module can be adjusted to be closer to one of multiple users at the digital piano 100 at the same time. Adjusting the position of the module allows the pedals 230 of the pedal and subwoofer assembly 200 to be reached by the user so that the tactile feedback provided by the subwoofer 106 can be felt by the user.

The foot pedal mechanism 104 can include one or more pedals 230. For example, the foot pedal mechanism 104 includes three pedals 230: a soft pedal (sometimes referred to as an una corda), a sostenuto pedal, and a sustain pedal (sometimes referred to as a damper pedal). The soft pedal modifies the tone quality and strength of notes. The sostenuto pedal selectively sustains note(s) from keys that are pressed at the time of the sostenuto pedal being depressed. The sustain pedal causes all notes to be sustained as long as the sustain pedal is depressed, producing a “sympathetic resonance” effect. Other pedal types can instead or additionally be included, such as muffling pedals. In some implementations, the foot pedal mechanism 104 includes another number of piano pedals, e.g., one piano pedal, two piano pedals, or more than three piano pedals.

The foot pedal mechanism 104 can also include one or more pedal position sensors 232 associated with the pedals 230 for generating sensor signals that are received by the controller 108 for controlling the audible output, as discussed below.

The controller 108 can be located on the digital piano 100. For example in FIG. 1, the controller 108 is located in the portion of the digital piano 100 above the keys 102. The controller 108 can also be located apart from the digital piano 100, for example, and send and receive signals to the digital piano 100 wirelessly. The digital piano 100 can receive user input on the keys 102 and/or through the foot pedal mechanism 104, and the controller 108 can, based on the user input, operate a speaker 118 and/or a subwoofer 106 of the digital piano 100 to produce an audible output, as discussed below.

Methods of operating the digital piano 100 can vary in implementations. In some examples, the controller 108 (e.g., one or more microprocessors) can receive sensor signals indicative of user inputs (e.g., on the foot pedal mechanism 104 or the keys 102), and can send control signals that represent the audible output to be emitted. The controller 108 can be configured to cause the digital piano 100 (e.g., a speaker 118 or the subwoofer 106 of the digital piano 100) to produce an audible output based on user input on the keys 102 and/or on the foot pedal mechanism 104. In particular, at least part of the audible output is emitted by the speaker 118, and at least some of the audible output is emitted by the subwoofer 106. The audible output can correspond to the notes of the keys 102 that the user has pressed. The controller 108 can be operably connected to a user interface 110 that allows the user to select options for the audible output to be emitted (e.g., buttons or a panel on the digital piano 100).

The subwoofer 106 can emit at least a portion of the audible output. For example, the controller 108 can send control signals to the subwoofer 106 to emit notes based on user inputs to the keys 102 and the foot pedal mechanism 104. The controller 108 can send control signals to the subwoofer 106 that correspond to notes that fall within a range of frequencies. For example, the controller 108 can send control signals to the subwoofer 106 that correspond to notes of lower frequencies. In implementations, the lower frequency audible output emitted by the subwoofer 106 can be between 27 Hz and 200 Hz.

In some implementations, the controller 108 can be used to customize the audible output and thus customize the tactile experience of a user, for example, by allowing the user to set a custom range of frequencies so that the controller 108 sends control signals to the subwoofer 106 only for notes that fall within the custom range of frequencies. The controller 108 can also be controlled (e.g., using the user interface 110) to select settings for the audible output of the subwoofer 106, such as volume, filters, or effects, through the user interface 110. For example, the controller 108 can be used to select from a number of levels (e.g., low, medium, high) of a tactile feedback selectable by a user through the user interface 110. The controller 108 can then modulate one or more of the volume, filters, effects, equalization, boosters, enhancers, etc. to provide the level of tactile feedback that was selected by the user. A user could thus be able to select to what extent the audible output from the digital piano 100 would approximate the tactile feedback offered by an acoustic piano. For example, a user can customize the tactile feedback by adjusting the gain of lower frequencies. The user can adjust an overall volume or gain of the audible output, or adjust the gain of the lower frequencies individually, for example, by adjusting the volume, equalization, filters, boosters, or enhancers.

The controller 108 can be configured to modulate the audible output based on user input to the foot pedal mechanism 104. The controller 108 can alter the audible output depending on what pedal(s) the user has pressed. For example, each of the pedals 230 can have a corresponding function, which may be a predetermined function and/or a function configurable using the controller 108. For example, in some implementations, the three pedals 230a, 230b, and 230c are a soft pedal, a sostenuto pedal, and a sustain pedal, respectively.

The position(s) of one or more pedals 230 of the foot pedal mechanism 104 can determine characteristics of an audible output provided by a digital piano (e.g., the digital piano 100 of FIG. 1). The sensors 232a, 232b, and 232c in the foot pedal mechanism 104 are configured to output sensor signals indicative of the positions of the corresponding pedals 230a, 230b, and 230c. The sensors 232 are communicatively coupled to the digital piano 100 (e.g., connected by wires) such that the controller 108 receives the sensor signals or variations of the sensor signals (e.g., amplified, attenuated, filtered, and/or processed in one or more ways (e.g., using an analog-to-digital converter or a digital-to-analog converter)). In some implementations, the controller 108 receives the sensor signals or variations thereof wirelessly, e.g., over one or more wireless networks such as a Bluetooth network or a Wi-Fi network. The controller 108 can receive the sensor signals themselves or variations thereof. The sensor signals from sensors 232 received by the controller 108 are indicative of the positions of one or more pedals 230.

The digital piano 100 is configured to emit an audible output based on the position of at least one pedal 230 of the foot pedal mechanism 104, as indicated by the sensor signal(s) received by the controller 108. For example, in some implementations, actuation of a subset of keys 102 (e.g., one or more of the keys 102) of the digital piano 100 can indicate a particular audible output, and actuation of each pedal 230 can further indicate a sound modification of the particular audible output indicated by actuation of a subset of the keys 102 of the digital piano. The audible output emitted by the digital piano 100 corresponds to an audible output indicated by actuation of a subset of the keys 102 of the digital piano 100, as modified by the sound modification indicated by actuation of the pedals 230. For example, if pedal 230c is configured as a sustain pedal, the audible output can include sustained digital notes corresponding to the notes played on the keys 102 while the pedal 230c is pressed. As another example of sound modification, if pedal 230a is configured as a soft pedal, the audible output can include digital effects to mimic the tone modifications of an acoustic piano's soft pedal. In some implementations, the audible output can include a specific type of sound when one or more pedals are pressed, e.g., a sound of a particular type of instrument (e.g., with a note corresponding to a note played on the keys 102 of the digital piano 100) can be played when a given pedal 230 is pressed. In some implementations, the pedals 230 can be configured to serve control functions for the audible output, e.g., to toggle a sound or sound sequence (e.g., a background drum beat) on/off or to otherwise switch between function(s) of the digital piano 100.

In some implementations, the foot pedal mechanism 104 and/or the digital piano 100 is configurable to adjust how the position of each pedal 230 modifies the audible output indicated by the actuation of the subset of keys 102. For example, the user can interact with the user interface 110 to adjust a function of each pedal 230.

The audible output emitted by the digital piano based on the position of a pedal 230 may, in some implementations, be emitted based on a binary position of the pedal 230 (e.g., pressed or not pressed) or on an amount of depression of the pedal. For example, in some implementations, a degree of modification of the audible output (e.g., a strength of an added audio effect associated with the pedal) increases continuously as the pedal is pressed further towards the floor 112, e.g., as the amount of depression of the pedal 230 increases.

The audible output can be emitted by the speaker 118 and/or the subwoofer 106 of the digital piano 100. In some implementations, the digital piano 100 includes a speaker 118 or subwoofer 106 configured to output the audible output in response to receiving a control signal from the controller 108. The control signal can be an analog signal and/or a digital signal. The digital piano 100 can include digital circuitry, such as the controller 108, configured to receive signal(s) that include sensor signals output from one or more pedal position sensors 232 (or variations thereof) and generate an audible output based on the signal(s), as described above.

In some implementations, the pedal and subwoofer assembly 200 can include its own controller 160 for receiving sensor signals generated by actuation of the foot pedal mechanism 104 and transmitting these sensor signals to the digital piano 100 (e.g., the controller 108 of the digital piano 100). The controller 160 of the pedal and subwoofer assembly 200 can also receive control signals from the digital piano 100 (e.g., the controller 108 of the digital piano 100) and use these control signals to control the audible output of the subwoofer 106.

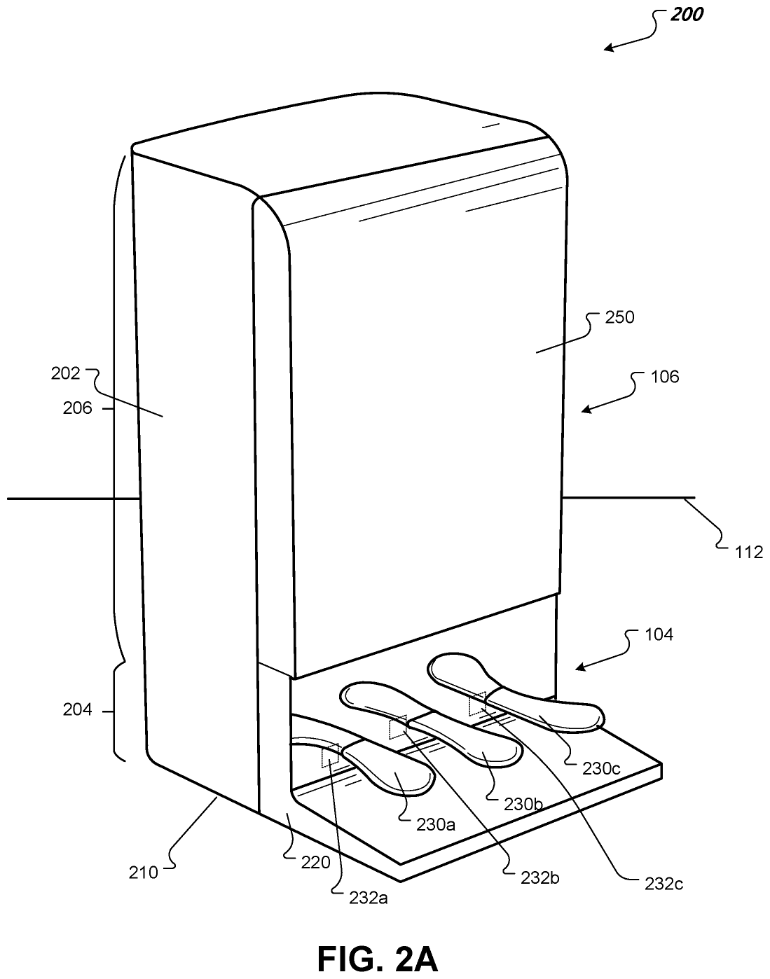

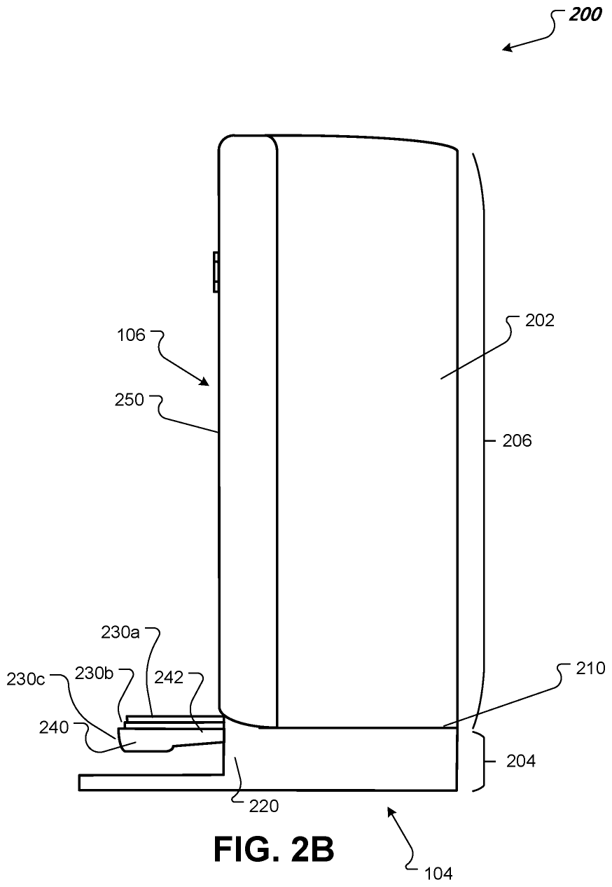

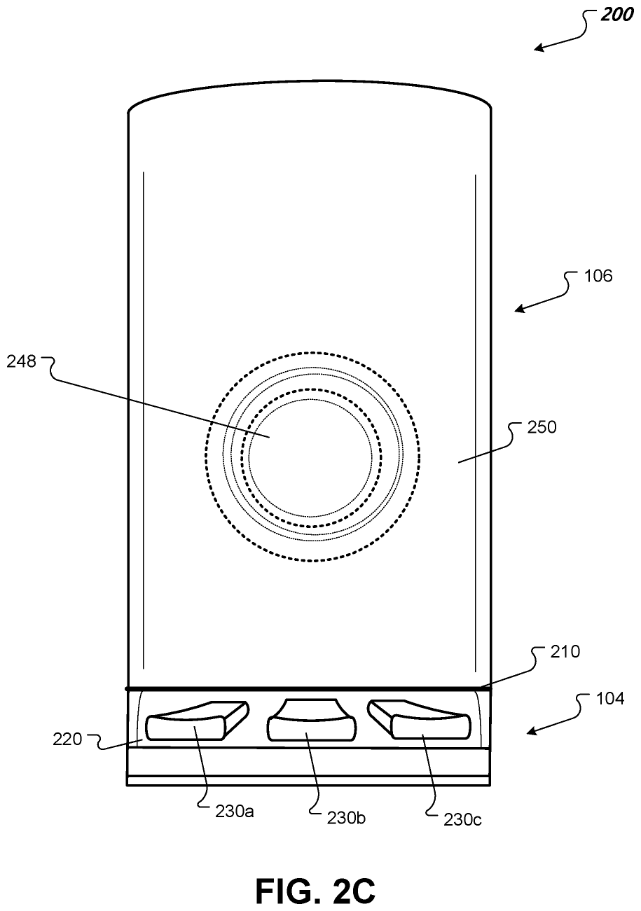

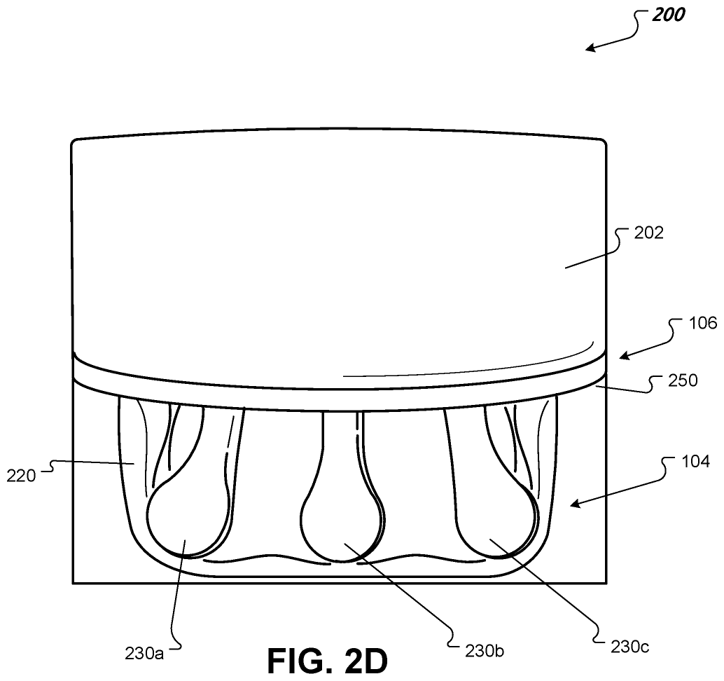

Referring to FIGS. 2A-2D and as described in this disclosure, the foot pedal mechanism 104 and subwoofer 106 can be part of the pedal and subwoofer assembly 200. The pedal and subwoofer assembly 200 can include a housing 202. The foot pedal mechanism 104 can be mounted to the housing 202, and the subwoofer 106 can be mounted to the housing 202. The pedal and subwoofer assembly 200 is mountable to the digital piano (e.g., the digital piano 100 of FIG. 1) below the keys of the digital piano.

The pedal and subwoofer assembly 200 can be positioned on the floor surface 112 when the pedal and subwoofer assembly 200 is mounted to the digital piano and when the digital piano is supported on the floor surface 112.

A bottom surface 210 of the pedal and subwoofer assembly 200 can be positioned on the floor surface 112. In FIGS. 2A-2D, the bottom surface 210 of the housing 202 is positioned on the floor surface 112, and supports the pedal and subwoofer assembly 200 above the floor surface 112.

In some implementations, the pedal and subwoofer assembly 200 can be positioned on the floor surface 112 through legs that are fixed to the bottom of the pedal and subwoofer assembly 200, for example, through legs that are fixed to the bottom surface 210.

In the example shown in FIGS. 2A-2D, a single housing 202 is used to house both the subwoofer 106 and the foot pedal mechanism 104, and the subwoofer 106 and the foot pedal mechanism 104 are integral to one another. The housing 202 includes a mechanical structure to which the foot pedal mechanism 104 and the subwoofer 106 are mounted and further mechanically supports the pedal and subwoofer assembly 200 above the floor surface 112. The housing 202 can at least partially enclose electrical and mechanical components of the foot pedal mechanism 104 and the subwoofer 106. As shown in FIG. 2A, the housing 202 includes a lower portion 204 where the foot pedal mechanism 104 is mounted and an upper portion 206 where the subwoofer 106 is mounted.

The housing 202 can include a base 220 to which the pedals 230 are mounted. The base 220 can form at least part of the lower portion 204 of the housing. The pedals 230 of the foot pedal mechanism 104 can be movably mounted to the lower portion 204 of the housing 202 (e.g., to the base 220 of the housing 202). For example, referring to FIGS. 2A-2B, each of the pedals 230 includes an extended, rigid member having a proximal end portion 240 and a distal end portion 242. At least part of the distal end portion 242 is mounted within the base 220. A position of the pedal 230 (e.g., for determining the audible output from the digital piano 100) can correspond to a position of the distal end portion 242 of the pedal 230, and the position of the distal end portion 242 of the pedal 230 can be detected by the pedal position sensor 232. The proximal end portion 240 is positioned outside the base 220 so that users can interact with the proximal end portion 240. The proximal end portion 240 is configured to be pressed down, e.g., by the foot of a user, thereby moving the distal end portion 242 and causing the audible output to be modulated based on the movement of the distal end portion 242. In addition, each of the pedals 230 is mounted such that the proximal end portion 240 is positioned in front of the subwoofer 106, thereby allowing the audible output from the subwoofer 106 to be directed toward the user (e.g., toward the feet of the user). As a result, the audible output from the subwoofer 106 can more readily provide tactile feedback to the user.

The subwoofer 106 includes a transducer for emitting an audible output. For example, the transducer can be an audio speaker 248. The structure of the speaker 248 can vary in implementations. In some implementations, the speaker 248 can be an enclosed speaker including an enclosure that is sealed so that no air can escape, allowing for more accurate notes and a smaller size for the subwoofer 106. The subwoofer 106 may not have any holes or breaks in its outer surfaces. The outer surfaces may be made of a material such as wood, metal, plastic, or composite. In some implementations, the speaker 248 can be a ported speaker including an enclosure with a vent so that air can escape, allowing for louder notes.

Dimensions of the subwoofer 106 can vary in implementations. The subwoofer 106 can have a height up to 100% of a height of a keyboard portion of the digital piano relative to the floor surface. For example, the keyboard can be positioned 800 millimeters from the floor surface. The subwoofer 106 can have an overall height between 100 and 800 millimeters (e.g., between 100 and 200 millimeters, between 200 and 300 millimeters, between 300 and 500 millimeters, between 500 and 800 millimeters, about 300 millimeters, about 500 millimeters, etc.).

The subwoofer 106 can have a height of about 500 millimeters, for example, to help localize the output and tactile feedback of the subwoofer to where a user's lower legs and feet are. The subwoofer 106 can have a height of about 800 millimeters, for example, to emit audible output over a larger area and to provide tactile feedback to the user as the sound waves travel through the area where the user's lower body is.

The subwoofer 106 can have a width up to 100% of the width of the digital piano. For example, the digital piano can have a width of 3000 millimeters. The subwoofer 106 can have an overall width between 100 and 3000 millimeters (e.g., between 100 and 200 millimeters, between 200 and 300 millimeters, between 300 and 400 millimeters, between 1000 and 3000 millimeters, about 200 millimeters, about 300 millimeters, etc.).

The subwoofer 106 can have a width of about 250 millimeters, for example, to cover the width of three pedals on the foot pedal mechanism 104 and to help localize the output of the subwoofer to where the feet of the user are. The subwoofer 106 can have a width of about 3000 millimeters, for example, to emit audible output over a larger area and to provide tactile feedback to multiple users at the same digital piano.

The subwoofer 106 can have a length up to 100% of the length of the digital piano. For example, the digital piano can have a length of 1000 millimeters. The subwoofer 106 can have an overall length between 100 and 1000 millimeters (e.g., between 100 and 200 millimeters, between 200 and 300 millimeters, between 300 and 400 millimeters, between 400 and 600 millimeters, between 600 and 1000 millimeters, about 200 millimeters, about 300 millimeters, etc.).

The subwoofer 106 can have a length of about 300 millimeters, for example, to allow the digital piano to have an overall size that is smaller and more accessible than an acoustic grand piano. The subwoofer 106 can have a length of about 1000 millimeters, for example, to allow for a higher maximum volume for the audible output of the subwoofer 106.

The speaker 248 of the subwoofer 106 can be directed laterally outwardly toward the foot pedal mechanism 104. The subwoofer 106 can output at least a portion of the audible output through the speaker 248. The speaker 248 can face outwardly towards an output cover 250 (e.g., defined by mesh or other material mounted to the housing 202) of the subwoofer 106 such that the audible output emitted by the subwoofer 106 tends to be directed outwardly through the output cover 250. When a user places their feet at the foot pedal mechanism 104 with the front part of their feet on the proximal end 240 of the pedals 230, the speaker 248 of the subwoofer 106 is directed toward the user's lower legs and feet, thereby providing a tactile experience similar to that of an acoustic grand piano when the audible output is emitted from the speaker 248.

A number of implementations have been described. While this specification contains many specific implementation details, these should not be construed as limitations on the scope of what is being claimed, which is defined by the claims themselves, but rather as descriptions of features that may be specific to particular implementations of particular inventions. It will be understood that various modifications may be made.

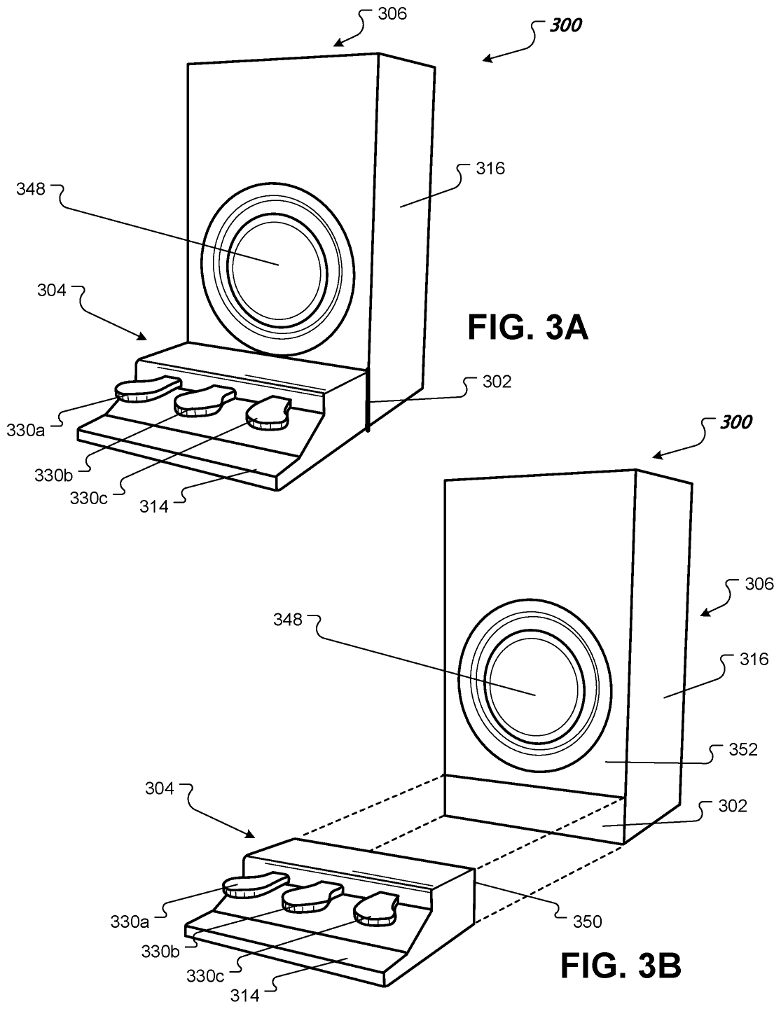

While the pedal and subwoofer assembly 200 of FIGS. 1 and 2A-2D has been described to include a single housing 202 that houses both the foot pedal mechanism 104 and the subwoofer 106, in other implementations, the pedal assembly 104 and the subwoofer 106 are separate devices that can be detachably connected to one another. FIGS. 3A-3B show an example of a pedal and subwoofer assembly 300 including a foot pedal mechanism 304 and a subwoofer 306. The foot pedal mechanism 304 is similar to the foot pedal mechanism 104 in the way that pedals 330 of the foot pedal mechanism 304 are operated to modulate an audible output from the subwoofer 306 and/or a speaker of a digital piano. And similarly, the subwoofer 306 is functionally similar to the subwoofer 106 in that the subwoofer 306 is configured to emit at least a portion of the audible output emitted by the digital piano.

The pedal and subwoofer assembly 300 differs from the pedal and subwoofer assembly 200 in that the foot pedal mechanism 304 and subwoofer 306 are detachably connected to one another. For example, the foot pedal mechanism 304 includes a housing 314 that is separate from a housing 316 of the subwoofer 306.

Referring to FIGS. 3A-3B, the foot pedal mechanism 304 is detachably connected to the subwoofer 306. For example, FIG. 3B shows that the foot pedal mechanism 304 can be separated from the subwoofer 306. The foot pedal mechanism 304 can be detachably connected to the subwoofer 306 through non-permanent attachment methods such as hooks and fasteners or magnets.

In some implementations, the foot pedal mechanism 304 and subwoofer 306 can include their own separate housings. The housing 314 of the foot pedal mechanism 304 can enclose the foot pedal mechanism 304 while leaving the pedals 330 exposed. The housing 316 of the subwoofer 306 can enclose the subwoofer 306 while leaving a speaker 348 exposed or covered by a material that allows sound waves to travel, such as fabric or mesh. The speaker 348 is similar to the speaker 248, for example, in its function and orientation.

In some implementations, the housing 314 of the foot pedal mechanism 304 can be attached to the housing 316 of the subwoofer 306, with an exterior surface of the housing 314 of the foot pedal mechanism 304 contacting an exterior surface of the housing 316 of the subwoofer 306. The exterior surface of the housing 314 of the foot pedal mechanism 304 can be attached to the housing 316 of the subwoofer 306 in a number of ways, including via fasteners, adhesives, or other methods. In some implementations, the housing 304 of the foot pedal mechanism 314 can be detachably connected to the housing 316 of the subwoofer 306 through non-permanent attachment methods such as hooks and fasteners or magnets. The housings 314 and 316 can be made of rigid materials or a combination of materials such as wood, metal, plastic, or composite.

The foot pedal mechanism 304 and the subwoofer 306 can be manually movable relative to one another to allow a user to place them in desired positions and to allow a user to customize the tactile feedback they receive from the pedal and subwoofer assembly 300. The subwoofer 306 can abut a rear portion of the foot pedal mechanism 304. For example, a rear outer surface 350 of the housing 314 of the foot pedal mechanism 304 can abut at least part of a front outer surface 352 of the housing 316 of the subwoofer 306.

In some implementations, at least one of the exterior surface of the foot pedal mechanism 304 or the exterior surface of the subwoofer 306 can include a cushioning member 302 where the foot pedal mechanism 304 and subwoofer 306 come into contact. The cushioning member 302 can be made of a material that absorbs movement when the subwoofer 306 or the foot pedal mechanism 304 move, e.g., from vibrations from soundwaves of the audible output from the subwoofer 306 or from the user pressing a pedal 330 of the foot pedal mechanism 304 and causing the foot pedal mechanism 304 to move. The cushioning member 302 can also reduce buzzing or rattling sounds as a result of the housing 316 of the subwoofer 306 and the housing 314 of the foot pedal mechanism 304 coming into contact with each other when the subwoofer 306 or the foot pedal mechanism 304 moves. For example, the cushioning member 302 can include a compact rubber such as ethylene propylene diene monomer rubber (EPDM).

For example, as shown in FIGS. 3A-3B, the rear outer surface 350 of the housing 314 of the foot pedal mechanism 304 can be in contact with at least part of the front outer surface 352 of the housing 316 of the subwoofer 306. FIG. 3B shows that the housing 316 of the subwoofer 306 includes a cushioning member 302. Alternatively or in addition, the housing 314 of the foot pedal mechanism 304 can include a cushioning member 302.

In some implementations, the housing 314 of the foot pedal mechanism 304 can include one or more port holes facing the subwoofer 306. For example, the port holes could be located in a rear panel of the housing 314 of the foot pedal mechanism 304 that can be in contact with the front outer surface 352 of the housing 316 of the subwoofer 306. The port holes can allow for sound wave dispersion of the audible output from the speaker 348 of the subwoofer 306.

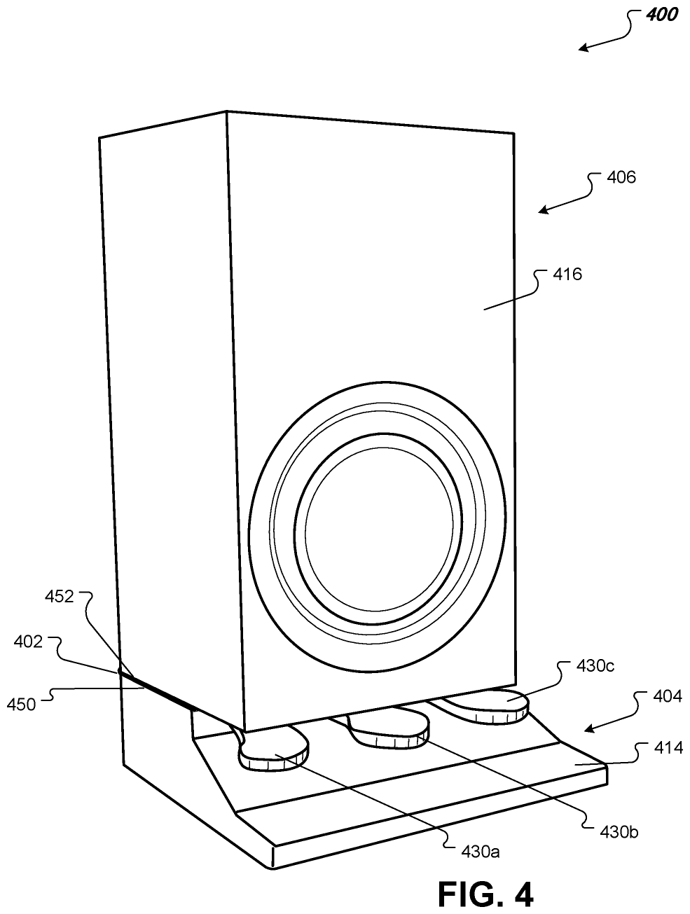

FIG. 4 shows an example of a pedal and subwoofer assembly 400 including a foot pedal mechanism 404 and a subwoofer 406. The foot pedal mechanism 404 and subwoofer 406 are similar to the foot pedal mechanism 304 and subwoofer 306 in that the foot pedal mechanism 404 and subwoofer 406 are detachably connected to one another and can include their own housings. For example, the foot pedal mechanism 404 includes a housing 414 that is separate from a housing 416 of the subwoofer 406.

The pedal and subwoofer assembly 400 differs from the pedal and subwoofer assembly 300 in that the subwoofer 406 of the pedal and subwoofer assembly 400 is positioned above the pedal assembly 404. For example, FIG. 4 shows that the housing 416 of the subwoofer 406 is positioned on top of the housing 414 of the foot pedal mechanism 404. A top outer surface 450 of the housing 414 of the foot pedal mechanism 404 can be in contact with at least part of a bottom outer surface 452 of the housing 416 of the subwoofer 406.

As described in this disclosure, the subwoofer 406 can be positioned to direct the audible output toward a location forward of the pedals 430 of the foot pedal mechanism 404 so that the audible output can provide tactile feedback to the user. In addition, as described in this disclosure (e.g., with respect to FIGS. 3A-3B), the subwoofer 406 or the foot pedal mechanism 404 can include a cushioning member 402 where the subwoofer 406 and the foot pedal mechanism 404 contact one another.

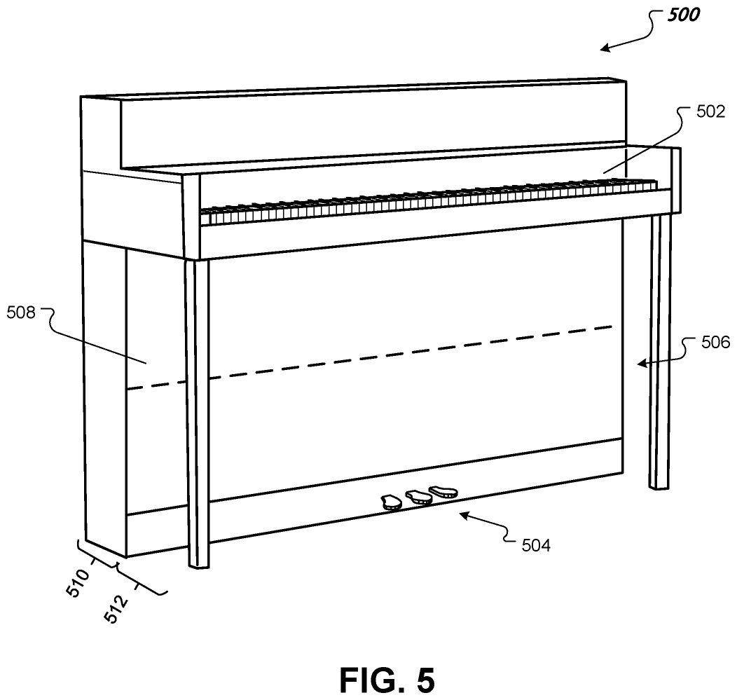

FIG. 5 shows an example digital piano 500 including a foot pedal mechanism 504 and a subwoofer 506. The digital piano 500 is similar to the digital piano 100 in that the digital piano 500 produces an audible output based on user input on the keys 502 and foot pedal mechanism 504, and at least a portion of the audible output can be emitted by the subwoofer 506. The foot pedal mechanism 504 and subwoofer 506 are functionally similar to the foot pedal mechanisms and subwoofers described in FIGS. 2-4, and in that, for example, the foot pedal mechanism 504 and subwoofer 506 are in contact.

The digital piano 500 differs from the digital piano 100 in that the subwoofer 506 is integrated into a panel 508 of the digital piano 500. The panel 508 extends along a rearward portion 510 of the digital piano 500 and covers at least a part of a forward portion 512 of the digital piano 500.

The subwoofer 506 can be positioned in the part of the forward portion 512 of the digital piano 500. For example, FIG. 5 shows the subwoofer 506 extending across the width of the forward portion 512 of the digital piano 500. The wider subwoofer 506 can help the digital piano 500 emit an audible output that is more resonant and that emulates the sound quality of an acoustic grand piano. The wider subwoofer 506 can also emit sound waves across the width of the digital piano 500, so multiple users at the digital piano 500 at the same time can experience vibrations from sound waves of the audible output transferring into their feet and legs.

In some implementations, the subwoofer 506 and the foot pedal mechanism 504 are integrated with the panel 508, providing a more traditional aesthetic appearance. For example, FIG. 5 shows the foot pedal mechanism 504 integrated with the panel 508 so that only the pedals of the foot pedal mechanism 504 are exposed. The subwoofer 506 is integrated with the panel 508 so that the subwoofer 506 is not exposed. The panel 508 can also include a material such as fabric that covers the subwoofer 506 but still allows sound waves to travel out from the subwoofer 506.

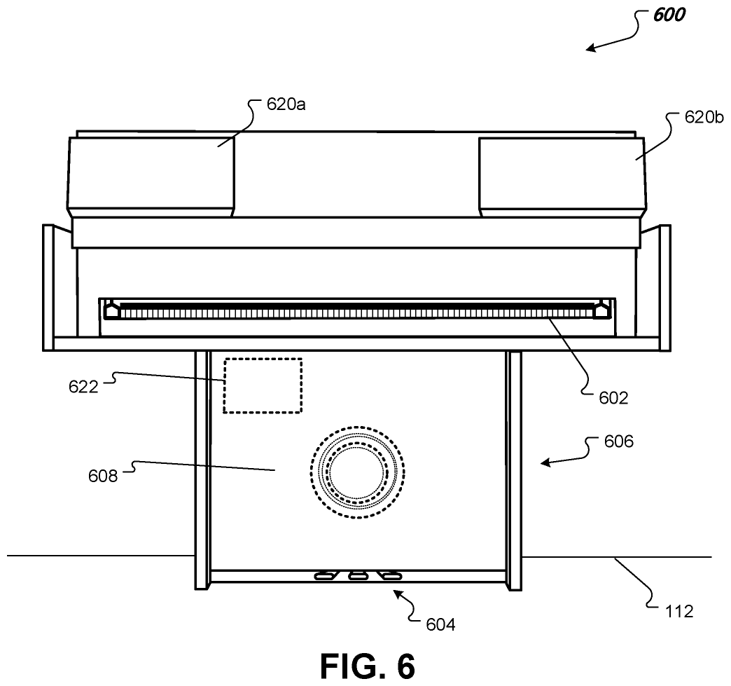

FIG. 6 shows an example digital piano 600 including a foot pedal mechanism 604 and a subwoofer 606. The digital piano 600 is similar to the digital piano 500 in that the subwoofer 606 is integrated into a panel 608 of the digital piano 600.

The digital piano 600 differs from the digital piano 500 in that the subwoofer 606 can be of a size sufficient to take up a large proportion of the panel 608, or in that a large proportion of the panel 608 can be covered by a material that allows sound waves to travel out of the subwoofer 606.

In some implementations, as shown in FIG. 6, the subwoofer 606 can be positioned on the floor surface 112 and support the keys 602 and the digital piano 600 above the floor surface 112. For example, the subwoofer 606 can have a height sufficient to support the keys 602 at a convenient height for a user to play. The larger subwoofer 606 can provide tactile feedback over a larger area, such as the user's lower body, when audible output is emitted from the subwoofer 606.

In some implementations, the subwoofer 606 and the foot pedal mechanism 604 can be positioned on the floor surface 112, and the digital piano 600 is supported on the floor surface 112 by the subwoofer 606 and the foot pedal mechanism 604, e.g., by a housing for the subwoofer 606 and the foot pedal mechanism 604.

The digital piano 600 further includes a speaker system, e.g., including speakers 620 and speaker 622, that are separate from the subwoofer 606. The speaker system includes a first portion, speaker 620a and speaker 620b, positioned above the keys 602, and a second portion that includes speaker 622, positioned below the keys 602. The second portion can also include the subwoofer 606. As described in this disclosure, the digital piano 600 can emit an audible output determined by user inputs on the keys 602 and the pedals of the foot pedal mechanism 604. The speakers 620 and 622 can emit a first portion of the audible output emitted by the digital piano 600, and the subwoofer 606 can emit a second portion of the audible output emitted by the digital piano 600.

While the pedal mechanism and subwoofer assemblies described in this disclosure have been described as having one subwoofer (e.g., having one speaker), in some implementations, a pedal and subwoofer assembly can include multiple subwoofers. The subwoofers can be integrated in a single housing or can each have separate housings that are attachable to one another. Multiple subwoofers can provide a tactile experience to multiple users at the digital piano at the same time, or can be configured to output different portions of the audible output, for example, different ranges of frequencies.

While the transducer of the subwoofer has been described as being configured to produce an audible output, in other implementations, the output of the transducer can include a sub-audible component. For example, the transducer can be configured as a tactile transducer or bass shaker that emits low-frequency vibrations. The low-frequency vibrations can be perceived by the user as tactile sound. The sub-audible component can thus provide an additional tactile experience for the user. For example, the transducer can be configured to emit low-frequency vibrations when a user plays particular keys on the keyboard.

Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

The subject matter and the actions and operations described in this specification (e.g., performed by controllers described in this specification, such as the controller 108 or the controller 160) can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

Accordingly, other implementations are within the scope of the claims.

What is claimed is:

1. A digital piano comprising:
a plurality of keys;
a foot pedal mechanism positioned below the plurality of keys;
a subwoofer positioned below the plurality of keys; and
a controller operably connected to the plurality of keys, the foot pedal mechanism, and the subwoofer, the controller configured to cause the digital piano to produce an audible output based on at least a user input on the plurality of keys, at least a portion of the audible output being emitted by the subwoofer.

2. The digital piano of claim 1, wherein:
the subwoofer is in contact with the foot pedal mechanism.

3. The digital piano of claim 1, wherein:
the foot pedal mechanism comprises a housing;
the subwoofer comprises a housing; and
the housing of the foot pedal mechanism is attached to the housing of the subwoofer, an exterior surface of the housing of the foot pedal mechanism contacting an exterior surface of the housing of the subwoofer.

4. The digital piano of claim 3, wherein:
the housing of the subwoofer is positioned on top of the housing of the foot pedal mechanism.

5. The digital piano of claim 3, wherein:
the housing of the subwoofer abuts a rear portion of the housing of the foot pedal mechanism.

6. The digital piano of claim 3, wherein:
at least one of the exterior surface of the housing of the foot pedal mechanism or the exterior surface of the housing of the subwoofer comprises a cushioning member.

7. The digital piano of claim 3, wherein:
the housing of the foot pedal mechanism comprises one or more port holes facing the subwoofer.

8. The digital piano of claim 1, further comprising:
a housing for the subwoofer and the foot pedal mechanism.

9. The digital piano of claim 1, wherein:
the foot pedal mechanism and the subwoofer form a module detachable from the digital piano.

10. The digital piano of claim 1, wherein:
the foot pedal mechanism is detachably connected to the subwoofer.

11. The digital piano of claim 1, wherein:
the subwoofer and the foot pedal mechanism are positionable on a floor surface when the digital piano is supported on the floor surface.

12. The digital piano of claim 1, further comprising:
a panel extending along a rearward portion of the digital piano, the panel covering at least a part of a forward portion of the digital piano,
wherein the subwoofer is positioned in the part of the forward portion of the digital piano.

13. The digital piano of claim 1, further comprising:
a panel extending along a rearward portion of the digital piano, the panel covering at least a part of a forward portion of the digital piano,
wherein the subwoofer and the foot pedal mechanism are integrated with the panel.

14. The digital piano of claim 1, further comprising:
a speaker system comprising a first portion positioned above the plurality of keys and a second portion positioned below the plurality of keys, the second portion of the speaker system comprising the subwoofer.

15. The digital piano of claim 1, wherein:
the subwoofer is an enclosed speaker.

16. The digital piano of claim 1, wherein:
a height of the subwoofer is no more than 500 millimeters;
a width of the subwoofer is no more than 250 millimeters; and
a length of the subwoofer is no more than 300 millimeters.

17. The digital piano of claim 1, wherein:
a speaker of the subwoofer is directed laterally outwardly toward the foot pedal mechanism.

18. The digital piano of claim 17, wherein:
the speaker of the subwoofer is positioned above the foot pedal mechanism.

19. The digital piano of claim 1, wherein:
the subwoofer and the foot pedal mechanism are positionable on a floor surface and the digital piano is supported on the floor surface by the subwoofer and the foot pedal mechanism.

20. The digital piano of claim 1, wherein:
the controller is configured to cause the digital piano to produce a sub-audible output based on at least the user input on the plurality of keys, at least a portion of the sub-audible output being emitted by the subwoofer.

21. A pedal and subwoofer assembly for a digital piano, the pedal and subwoofer assembly comprising:
a housing;
a foot pedal mechanism mounted to the housing, the foot pedal mechanism configured to generate one or more signals for the digital piano to modulate an audible output produced by the digital piano; and
a subwoofer mounted to the housing, the subwoofer configured to generate at least a portion of the audible output produced by the digital piano, wherein the pedal and subwoofer assembly is mountable to the digital piano below keys of the digital piano.

22. The pedal and subwoofer assembly of claim 21, wherein the pedal and subwoofer assembly is positionable on a floor surface when the pedal and subwoofer assembly is mounted to the digital piano and when the digital piano is supported on the floor surface.

23. The pedal and subwoofer assembly of claim 21, wherein:
a speaker of the subwoofer is directed laterally outwardly toward the foot pedal mechanism.

24. The pedal and subwoofer assembly of claim 23, wherein:
the speaker of the subwoofer is positioned above the foot pedal mechanism.

25. The pedal and subwoofer assembly of claim 21, wherein:
the subwoofer is an enclosed speaker.

26. The pedal and subwoofer assembly of claim 21, wherein:
a height of the subwoofer is no more than 500 millimeters;
a width of the subwoofer is no more than 250 millimeters; and
a length of the subwoofer is no more than 300 millimeters.
